(19) United States
(12) Patent Application Publication
(10) Pub. No.: US 2007/0127693 A1
(43) Pub. Date: Jun. 7, 2007

(54) Consumer feedback method and apparatus

(75) Inventors: Frank J. D'Ambrosio, San Francisco, CA (US); John R. MacIntosh, Menlo Park, CA (US)

Correspondence Address: MORRISON & FOERSTER LLP, 425 MARKET STREET, SAN FRANCISCO, CA, 94105-2482, US

(73) Assignee: VOX, LLC, Menlo Park, CA (US)

(21) Appl. No.: 11/603,910

(22) Filed: Nov. 21, 2006

Related U.S. Application Data
(60) Provisional application No. 60/738,712, filed on Nov. 21, 2005.

(51) Int. Cl. H04M 3/00; H04M 5/00

(52) U.S. Cl. 379/265.06

(57) ABSTRACT

An intermediary service allows a customer to share, anonymously or not, feedback information with the provider via the intermediary service over a network, and provides expectations that the feedback information will be appropriately addressed. The provider will store in the intermediary a set of rules including escalating rules to escalate the feedback information to entities within the provider according to an escalation order, and rules for responding to feedback information within a time period. After receiving a response from a provider via the intermediary the customer is asked to indicate a level of satisfaction with the provider response and has the option of escalating the feedback information to another entity according the escalation rules or closing the communication with provider via the intermediary concerning the feedback information.

### CROSS-REFERENCE TO RELATED APPLICATIONS

This patent application claims priority to U.S. Provisional Patent Application Ser. No. 60/738,712, filed Nov. 21, 2005, which is expressly incorporated herein by this reference.

### BACKGROUND OF THE INVENTION

1. Field of the Invention

The present application relates in general to resolution of customer feedback issues that arise from interactions with providers and, more particularly, to mediating communication between a customer and a consumer service or product provider to achieve an effective resolution efficiently.

2. Description of the Related Art

An increasing divide has developed between customers and providers of everyday products and services. As consumer-oriented businesses get larger and become more organizationally complex, become more automated, and more focused on near-term performance expectations in lieu of longer-term relationships, it has become increasingly difficult for ordinary customers to be heard. The more impersonal customer-oriented businesses have become, the more difficult it becomes for customers to voice concerns and the more difficult it becomes for those providers to accurately hear those concerns in a timely manner.

Today, when customers want to be heard by a customer service or product provider, they often have to search through a variety of sources using a variety of methods that are difficult to locate and/or difficult to use. The level of difficulty sometimes can be so great that many customers give up and do not even bother contacting the service or product provider. In the case of customers with a complaint it is estimated that between 65%-90% do not complain to the entity because of the time and effort it takes to have their voice heard; they don't know where or how to complain or they do not believe it will do any good. Over time customers feel powerless and under valued and are susceptible to switching their allegiances to a competing provider.

With world economies moving more towards “Service Economies” where product and price differentiation become less attainable, the ability of a provider to understand and respond to customer experience issues may become one of the greatest factors influencing customer loyalty.

Currently, it is far too difficult for customers to be heard about things that matter to them when they matter. For providers it is too unwieldy and expensive to have accountability and desired responses to clearly understand and then improve the customer experience.

Customers may include, but are not limited to, consumers, employees, voters/taxpayers, students, and investors. Providers may include, but are not limited to, government agencies, officials (e.g. TSA Parties, Police), corporations (e.g. retailers, broadcast, telecom, media, financial, healthcare), and educational institutions.

Many of these providers have a method of soliciting and/or submitting customer feedback. Feedback may include positive, negative, and neutral statements. However, these methods are not uniform and may be unique to the provider, making it difficult for the customer to easily submit feedback to more than a few of the many providers she interacts with. Furthermore, a customer usually wants to know that she has been heard by the right person(s). She wants a meaningful response to feedback delivered to a provider. With current feedback methods, the provider may or may not provide a response or an appropriate action.

For example, a provider may allow for a website submission of feedback/survey customer information, such as company websites that offer links for “customer service” or “contact us.” After receiving bad customer service, the steps to submit a complaint may happen as follows, for instance. A customer would-have to conduct an online search to find the provider website. After searching the website, no apparent link to submit a complaint or feedback is found, and a link such as “Contact Us” is chosen. After filling out personal information, such as name, email address, or mailing address, the customer may have to fill out a generic form that may contain questions that may not be relevant to the complaint. After submission of the complaint, a generic email may be sent back confirming receipt of the complaint, but not necessarily guaranteeing a response. The customer does not know who read the complaint and may have to make an extra effort to contact the provider to follow-up on the complaint.

Another example of how a system for current feedback/survey information is implemented is an automated telephone system. These systems provide customers with voice instructions and often require the customer to use the telephone push-button numbers to submit answers. After dialing a phone number, the customer may be directed through a series of menus. If the customer wishes to speak with a person, the menu choice may not be obvious and the customer may not ever find the correct option.

A live-operator telephone system may also be used. Due to a large volume of calls, a customer may be placed on hold for a period of time. The customer also may be required to give her name, telephone number, and address, for example. Some customers may feel that they do not want to divulge their personal information. The operator may be able to reassure the customer verbally that her feedback will be directed to the appropriate person within the provider, but there is no guarantee that anybody will actually respond to the customer. Additionally, it may take a considerable amount of time to be transferred to the appropriate person within the provider, or may not be possible at all to get the feedback to the appropriate person.

Other service providers may offer comment cards for a customer to provide feedback/survey information. However, such cards often ask the customer to fill out personal information and are geared toward survey type questions rather than feedback such as a complaint. The time to get a response could be significant, or the provider may not respond at all.

Currently, there are a variety of ways to provide customer information, which may not be effective, may not allow a customer to accurately describe her customer experience, and the customer may not get any kind of response from the provider. Therefore, the customer has no reassurance or satisfaction that the information she provides is making a difference. On the other hand, providers may not be effectively using customer feedback to improve the customer experience, or to address problems within the provider. The provider may be losing customers because of an inability to manage customer information efficiently and effectively. Therefore, there is a need for a uniform and effective way to manage communication between customers and consumer service or product providers.

### SUMMARY OF THE INVENTION

In one aspect a method is provided for operating an intermediary service for mediating communication between a customer and a provider over a network. The intermediary stores a set of rules for the provider used for managing customer feedback information submitted by customers. The rules include rules for routing the customer feedback information to appropriate entities within a provider according to an escalation order. Additionally, the rules include rules for responding to customer feedback information within a time period. A customer feedback submission protocol is customized by the provider and provided over a network to the customer to submit the customer feedback information. The customer feedback information concerning a customer experience is received over a network by the intermediary. The intermediary: (1) provides over the network the customer feedback information to the entity within the provider according to the escalation order, (2) provides over a network to the customer an indication of at least one action to be taken by the provider in response to the customer feedback information, (3) provides over a network to the customer a time period for response to the customer feedback information as set by the provider, (4) receives over a network from the provider a response indicating a performance of at least one action in response to the customer feedback information, and (5) receives from the customer an indication of a level of customer satisfaction with the received response from the provider. If the received indication of the level of customer satisfaction indicates the customer is not satisfied, then the customer feedback information is escalated to the next entity in the escalation order and steps (1)-(5) are repeated.

In another aspect a system mediates communication between a customer of a plurality of customers and a provider of a plurality of providers over a network. A memory that is accessible by a processor stores information associated with each customer session of a plurality of customer sessions and information associated with each provider of a plurality of providers. The information associated with each customer session includes customer feedback information associated with a customer experience submitted by a customer. The information associated with each provider includes rules for managing customer feedback information and a customized customer satisfaction submission protocol. The rules include rules for routing the customer feedback information to appropriate entities within the provider according to an escalation order. The rules also include rules for responding to the customer feedback information within a time period. A processor in the system processes the information associated with each customer session and the information associated with each provider. A customer interface provides and receives information from a customer. A provider interface provides and receives information from a provider.

In yet another aspect, an article of manufacture is provided that includes a computer readable medium encoded with computer code for causing a computer to perform a process. The process is associated with operating an intermediary service for mediating communication between a customer and a provider over a network. The process includes an intermediary storing a set of rules for the provider used for managing customer feedback information submitted by customers. The rules include rules for routing the customer feedback information to appropriate entities within a provider according to an escalation order. Additionally, the rules include rules for responding to customer feedback information within a time period. The process further includes providing a customer satisfaction submission protocol over a network that is customized by the provider used for the customer to submit the customer feedback information. The customer feedback information concerning a customer experience is received over a network by the intermediary. The process further includes (1) providing over the network the customer feedback information to the entity within the provider according to the escalation order, (2) providing over a network to the customer an indication of at least one action to be taken by the provider in response to the customer feedback information, (3) providing over a network to the customer a time period for respond to the customer feedback information by the provider, (4) receiving over a network from the provider a response indicating a performance of at least one action in response to the customer feedback information, and (5) receiving from the customer an indication of a level of customer satisfaction with the received response from the provider. If the received indication of the level of customer satisfaction indicates the customer is not satisfied, then the process includes the customer feedback information is escalated to the next entity in the escalation order and steps (1)-(5) are repeated.

### BRIEF DESCRIPTION OF THE DRAWINGS

FIG. 1 is an illustrative block diagram of an embodiment of an interaction between customers and providers through an intermediary;

FIG. 2 is an illustrative block diagram of the business entity site and associated information of the customer, intermediary, and provider;

FIG. 3 is an illustrative schematic of an embodiment of the intermediary system;

FIG. 4 is an illustrative embodiment of the invention of mediating communication between a customer and a provider;

FIG. 5A is an illustrative embodiment of a customer feedback information protocol as a template;

FIG. 5B is another illustrative embodiment of a customer feedback information protocol as a template;

FIG. 6 is an illustrative embodiment of the customer feedback information in the mediation process by the intermediary between the customer and a provider according to escalation rules;

FIG. 7 is an illustrative flowchart of an embodiment of a customer beginning a session to submit a customer information; and

FIG. 8 is an illustrative flowchart of an embodiment of a provider initial interaction with the intermediary.

### DETAILED DESCRIPTION OF THE PREFERRED EMBODIMENTS

The following description is presented to enable any person skilled in the art to make and use a system and method for mediating communication between customers and consumer service or product providers. Embodiments of the invention are described, but are not limited to, as a “Cheers & Jeers” platform (C&J) or an intermediary service. The description discloses the system and method in accordance with embodiments of the invention and in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention can be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein.

Definitions:
Customer—Anyone who is on the receiving end of a product or service provided by businesses, schools, governments, non-profits or any other type of institution.
Provider—any provider that receives feedback from customers. This means that they have received customer information from an intermediary and have access to the terms and conditions of the intermediary.
Customer feedback information—includes, but is not limited to, positive, negative, or neutral statements, which can include complaints, compliments, suggestions, and comments.
Communications device—includes but is not limited to personal computers, telephones (land/mobile), hand-held devices, kiosks, etc.
Network—includes but is not limited to the Internet, telephone networks, mobile networks, wi-fi and any others existing or future whereby data is transmitted digitally.

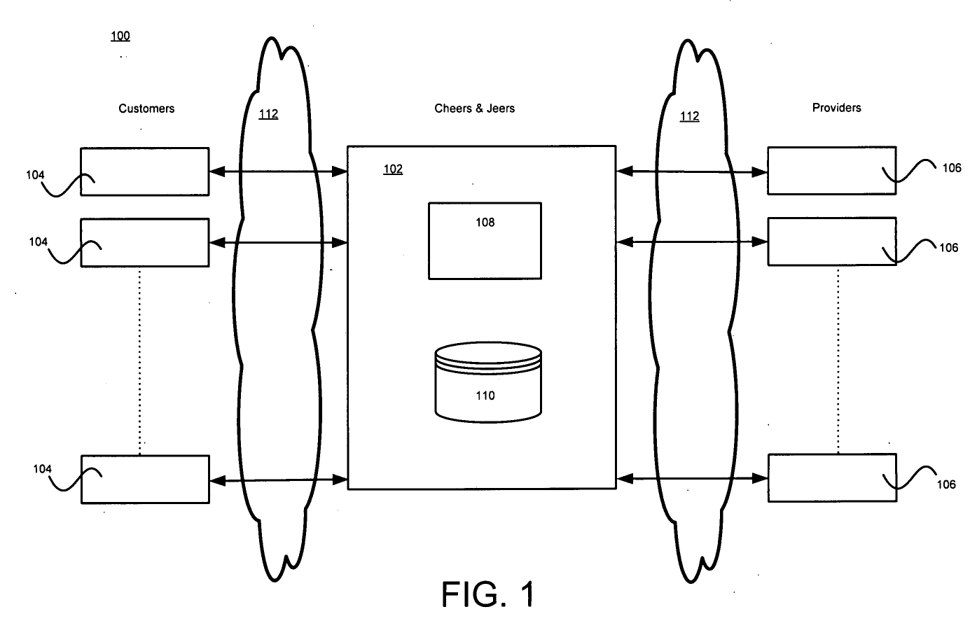

FIG. 1 is a schematic block diagram illustrating one embodiment of the customer interaction with the intermediary service. The intermediary 102, includes a processor 108 and memory 110. There is communication between intermediary 102 and each provider 106 over a network 112. In addition there is communication between intermediary 102 and each customer 104 over a network 112.

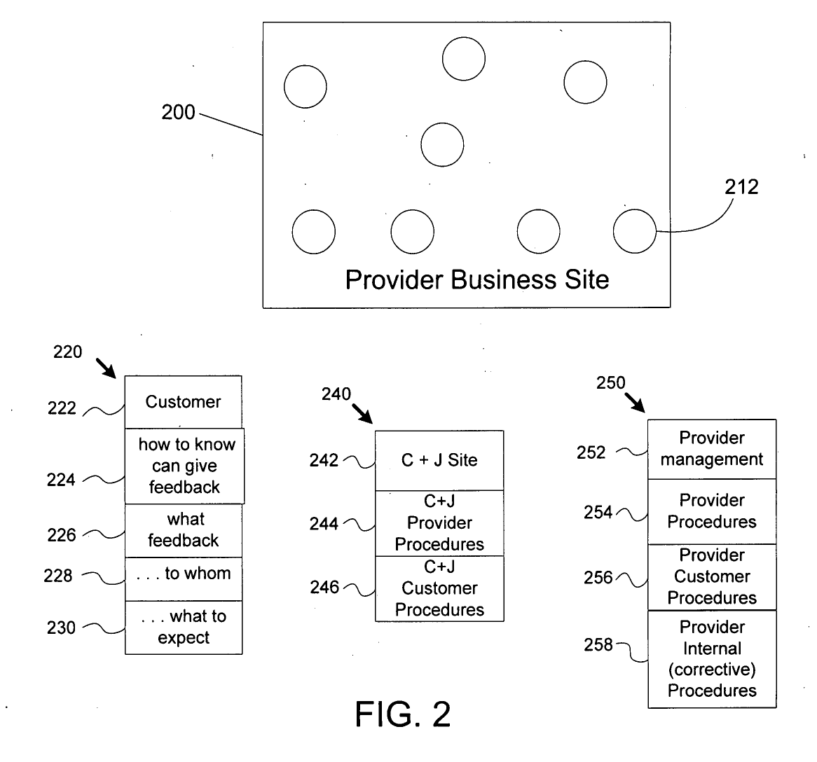

FIG. 2 is an illustrative schematic showing the customer and provider in relation to the intermediary.

In the drawings, item 212 represents a provider that a customer might interact with. It might be a retail outlet of a global coffee shop chain. Alternatively, it might be the individual store located on the corner of Main and Center Streets in Hometown. Items 250 represent different components of the provider. They might represent individual stores, individual people within the store or individual products or services offered by the store.

Items 220-222 represent a customer. Items 224-230 represent some of the current practical considerations that a customer might have to address in interacting with an intermediary. Items 240-242 represent the intermediary service. Item 244 represents procedures that intermediary undertakes in relation to the provider. An example set of steps/interactions/communications to interact with providers is described below. Item 246 represents procedures that the intermediary undertakes in relation to customer. Items 250-252 represent the entity management. Item 254 represents procedures that entity management undertakes in relation to intermediary. An example set of steps/interactions/communications by which the provider entity management interacts with the intermediary service are described below. Item 256 represents procedures that provider's management undertakes in relation to customers. A set of example steps/interactions/communications by which the provider's management interacts with customers is described below. Item 258 represents procedures that provider's management undertakes in relation to itself.

The intermediary service employs business rules to route customer information concerning customer experience, and to track provider actions/responses and associated customer satisfaction in response to the customer information. The intermediary service will work with a provider to configure the system, to ensure information gets to the right person(s), at the right times, in the right format(s). The intermediary service reminds entities within the provider to respond to the inputs of the customer within the time committed to by the provider and may provide entities within the provider with approved or acceptable responses set by the provider. Additionally, status of responses or actions related to the customer information may be communicated to all appropriate provider parties.

Embodiments of the invention provide to customers a venue having a uniform approach to providing feedback on their experiences and opinions of the products, policies, personnel, etc. to the many organizations they encounter. An intermediary service makes it easy to provide information about a customer experience and immediately delivers the customer information to the appropriate person(s) who do something with and respond to the customer's information.

Embodiments of the invention serve as an independent third party whereby communications between customers and providers may be captured, routed, tracked and monitored. It imposes business rules that will enforce responsiveness and accountability while reliably communicating providers' responses to their customer's feedback.

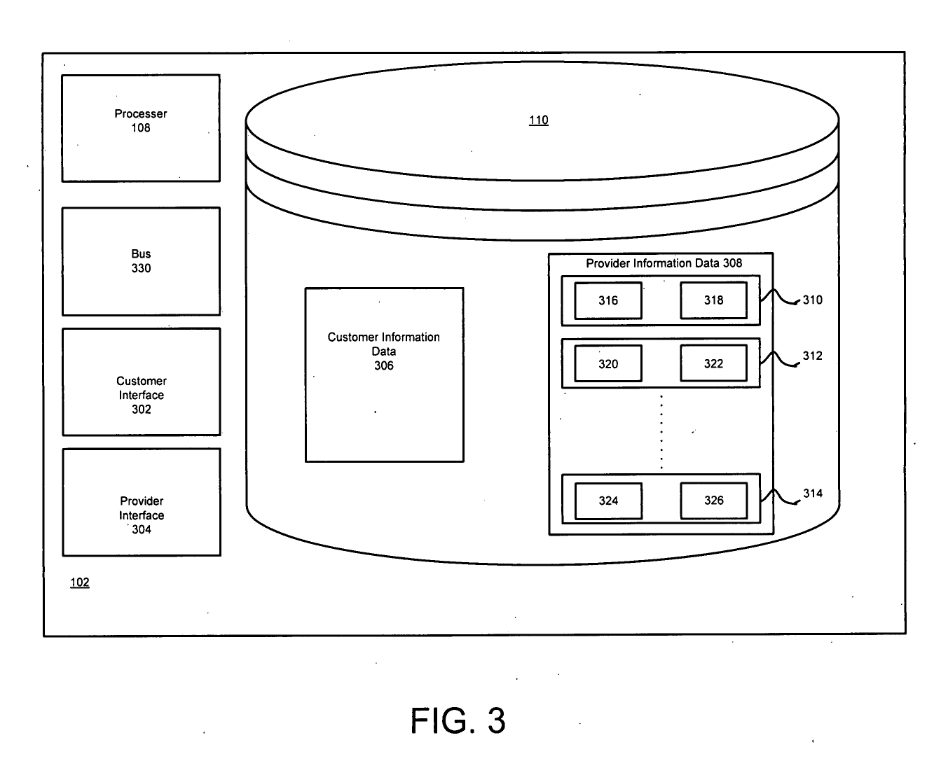

FIG. 3 is an illustrative block diagram of embodiments of the system 102. The system 102 includes a processor 108, customer interface 302, provider interface 304, and memory 110. A bus 330 interfaces the memory 110 with the processor 108. The data related to the communication between the customer and provider is stored in memory 110. The memory 110 stores data related to the customer 306, as well as data related to the provider 308, including data related to the provider interactions with the intermediary service. Customer data 306 may include, for example, information of the submitted customer information associated with individual customers, and customer personal information, such as e-mail addresses. The customer data is input into the system and stored in the memory via the customer interface 302. Provider data 308 may include customized customer information templates 316 and rules 318 associated with each provider. For example, provider 310 has a customized template 316 and personalized rules 318, but provider 312 has a different template 320 and different personalized rules 322. Likewise, provider 314 has its own customized template 324 and rules 326. The provider data is input into the system via a provider interface 304. The processor 108, for example, processes the appropriate provider rules to determine the entity customer information should be routed to for that provider.

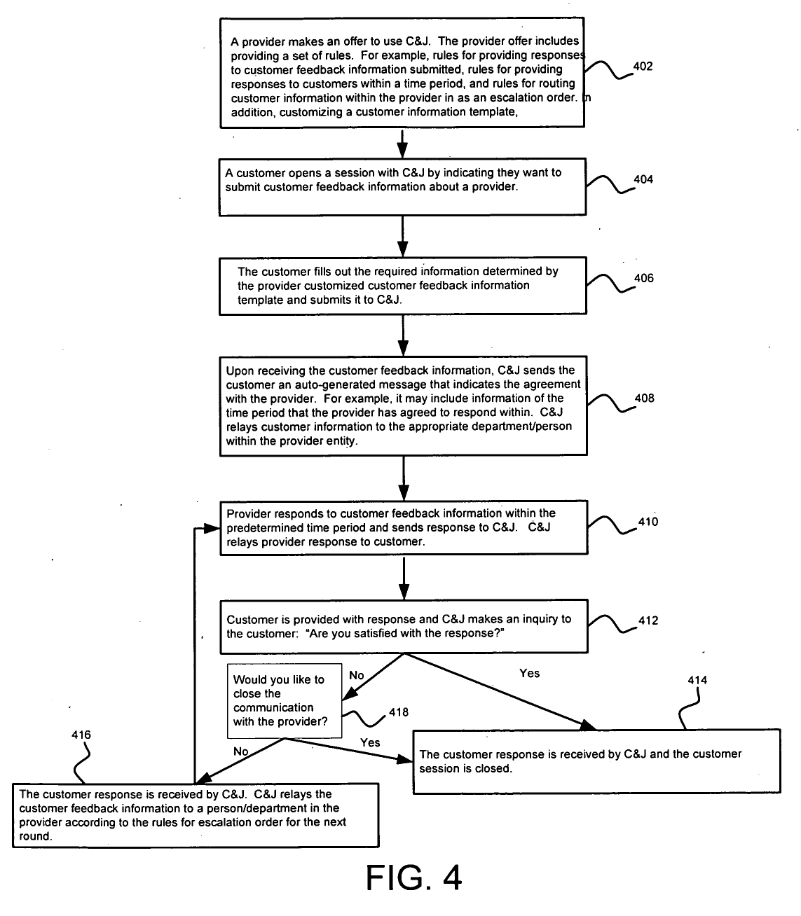

FIG. 4 is an illustrative flowchart showing, an example of how communication is mediated by embodiments of the invention. In step 402, the provider makes an offer to use the service of the embodiments of the invention. The offer includes rules, which may include, but are not limited to, rules to provide responses to customer information directed to the provider, and rules to provide responses to the customer information within a time period. Moreover, the provider provides rules for routing the customer information to different entities within the provider. In particular, the provider provides an escalation order, which lays out the hierarchy of entities within the provider that may need to receive customer information. Entities may include individual people, such as a customer service representative, a manager, or a district manager. Entities may also include departments within the provider.

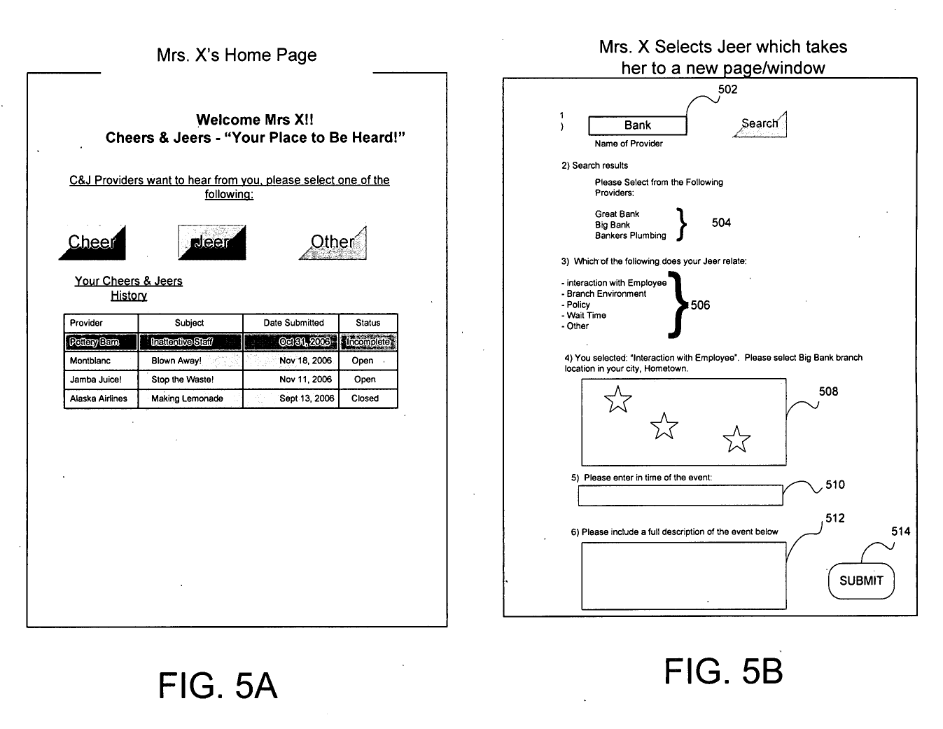

The provider will also be provided with a template with fields that customers will use to submit their information. The provider customizes the template to allow the customer to give adequate details for any particular experience. In this way, routing rules associated with fields in the template allows the intermediary to determine the entity that the customer information will be routed to according to the routing rules set by the provider in step 402. FIG. 5A illustrates an example of a webpage associated with the submission of customer feedback information. FIG. 5B illustrates an example of the customer feedback information submission template page with provider customized questions. Question/answer fields 502 and 504 refer to the submission of the provider name. Question/answer field 506 is generated by selecting the provider name in 504. Question/answer field 506 is a general question related to the banking industry. In this example, the customer, Mrs. X, wants to submit information relating to bad customer service by a teller. After choosing she would like to submit information about “interaction with an employee” in 506, the next question/answer field 508 provides a map to select the specific branch of the bank. Subsequent question fields are generated 510-512 to be provided to the customer to fill in information relating to the event, such as time of day 510, and description of event 512. After the customer has entered in the information, she presses a submission button 514 to send her customer feedback information to the intermediary.

In step 404, the customer begins a session with an intermediary by accessing the customer interface and indicating she would like to submit customer feedback information concerning a customer experience. The customer enters the customer feedback information in the template customized by the provider in 406.

In step 408, the customer feedback information is received by the intermediary and an acknowledgement that may be an auto-generated message, is provided to the customer. The acknowledgement message may also include the time for response commitment set by the provider. Therefore, the customer may have reasonable expectations of when to expect a response from the provider. For example, these expectations may be the time in which they should receive a response, and who the customer can expect to get a response from. Furthermore, the intermediary may also provide reminders to the provider to respond within the committed time for response. The intermediary will route the information according to the routing rules to the appropriate entity within the provider.

After a provider response is received by the intermediary, it is transmitted to the customer, as in step 410. The response may or may not be acceptable to the customer. Embodiments of the invention allow the customer to indicate whether or not the provider response is satisfactory 412. If the customer is satisfied with the provider response, then the intermediary accomplished a successful mediation of customer feedback information to a provider and resolving the issue. The session between the customer and provider associated with the customer feedback information is closed 414. However, in step 412, if the customer indicates that she is not satisfied, then the customer is asked if she would like to close the session related to her customer feedback information anyway in step 418. If she does not want to close the session, then the intermediary escalates the unresolved customer information to the entity according to the escalation order set by the provider in 402 in step 416, and are repeated until either the customer indicates they are satisfied with the provider response, or they no longer want to continue pursuing another response from the provider. In the latter case, the intermediary provides the customer the information that this is the end of the escalation order and no more can be done. However, the customer will at least know that the customer information that was submitted was read at least all applicable entities in the escalation order within the provider. At the conclusion of all customer feedback events, the intermediary may ask the customer about current and further intentions, such as repurchase, recommendations, etc.

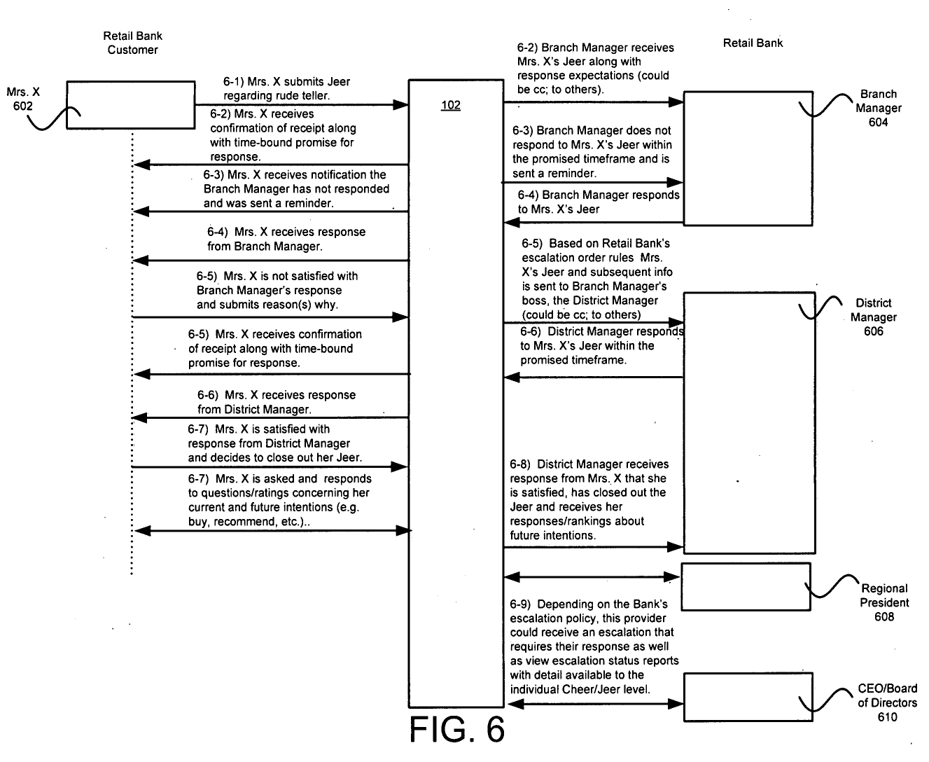

FIG. 6 is an illustrative flowchart showing an example of mediation of specific customer feedback information according to an escalation order determined by the provider. For example, Mrs. X is a customer 602 at a bank and receives bad customer service from a teller. In step 6-1, Mrs. X submits information concerning a negative satisfaction to the intermediary 102. With reference to FIG. 3, as an example, the bank is the provider 310. The customer feedback information submitted by Mrs. X is routed from the intermediary 102 to an entity within the provider, a Branch Manager 604 according to an escalation order of the rules 318 in step 6-2, again with reference to FIG. 3. In step 6-2, Mrs. X receives confirmation from the intermediary 102 of receipt of customer feedback information along with the time period the provider has set to respond within according to the rules 318. In step 6-3, the Branch Manager does not submit the response in the response time period. The intermediary 102 sends a reminder to the Branch Manager and updates Mrs. X 602 that the Branch Manager 604 has not responded in step 6-3. The Branch Manager 604 responds to the customer feedback information and Mrs. X 602 receives the response from the intermediary 102. Mrs. X 602 then indicates her level of satisfaction with the provider response. In step 6-5, Mrs. X submits an indication to the intermediary 102 that she is not satisfied with the Branch manager's response. The intermediary 102 then routes the customer feedback information to the next entity within the provider set in the escalation order rules. In this example, the District manager 606 is the next entity. Mrs. X 602 receives a confirmation that the District manager 606 has received her customer feedback information. In step 6-6, the District Manager 606 responds to Mrs. X customer feedback information to the intermediary 102, and the intermediary 102 then sends the response to Mrs. X 602. In step 6-7, Mrs. X 602 indicates she is satisfied with the response from the District Manager 606. Mrs. X 602 is then asked to provide information relating to her current and future intentions concerning the provider, such as if she intends to recommend the bank 310 to her acquaintances. In step 6-8, the District Manager 606 receives from the intermediary 102 that the customer was satisfied and information submitted about her current and future intentions. In step 6-9, the bank 310 may set in the escalation order that other entities within the provider are provided with the history of the customer feedback information.

Accessing C&J

Customers access the intermediary service via a variety of communication devices that are connected to the “global communications network” including, but not limited to, personal computers, telephones (land line and mobile), handheld devices, kiosks, etc. The methods for accessing the intermediary service include, but are not limited to: C&J hyperlink embedded into Web browser toolbars, operating systems, telephone displays, applications, 3rd party Web sites/pages or other such ways customers use the aforementioned devices to exchange information; Direct access may be via, for example: a website such as www.cheersandieers.com/org; on-location or in-store kiosks with C&J interface pre-configured to the specific location/store (e.g. in a clothing retail store, Department of Motor Vehicles, etc.); Any form of banking (paper/online) and/or credit card statements with a direct link presented alongside specific account transactions; and Transactions from participating organizations will automatically display the intermediary icon next to each transaction whereupon selecting the link the user will be transferred to the intermediary along with other relevant details of the transaction being passed and automatically populated in the intermediary feedback submission fields (e.g. the specific organization along with other details of the transaction including place, time, product/services, customer service rep ID, amount, etc.).

Text or voice messaging to initiate and/or complete a session related to a customer information submission. Initiated sessions can be saved for completion by the customer at a later time and will be marked as incomplete, in-process or closed. Additionally, embodiments of the invention generate a reminder to their email, voicemail account and/or personal website to complete the initiated session.

An on-location/in-store transmission device that enables customers to initiate a session via their preferred communications device. The customer may initiate a “call” to the transmission device which will automatically recognize the customer's preferred communication device and generate a welcome that asks the customer if they'd like to provide feedback (yes/no). If yes, the intermediary asks the customer if they'd like to do so now or later (with reminder sent by the intermediary). Alternatively, the customer could be presented with an access number in the store whereby entering a specific number(s), input key or voice command that automatically connects them to the intermediary.

1-800-C&J with options for live person or IVR. Consumer can call into the C&J 800# and either go through an IVR tree and/or speak with a live person who will simply capture their inputs and enter them into the system (with option for customer to review prior to submitting).

Paper-based input form that can be mailed and/or faxed to the intermediary. A paper-based customer feedback information form may be accessible online at a web site or by contacting participating providers. Paper-based input forms may be located on-site/in-store with some preprinted barcode info (store number, etc.). These forms contain specific information for completing the customer information. Additionally, upon request or automatically, location personnel can print a customer information form with customer specific data either already populated and/or with a transaction code that identifies the store, customer, time and any other information relevant to completing the customer information. The transaction code will be provided by the participating organization to the intermediary so that when the customer enters it in their customer information submission all relevant information will be auto-populated.

All customer information submissions will receive an automatic acknowledgement of receipt along with a tracking number and link to a summary page with the customer's private information along with access to any archived feedback previously submitted.

Identifying Participating Provider Organization Location, Staff and Customer

Organizations can be identified either by customer input or automatically by a C&J identification codes displayed on the premises and/or transmitted to the customer's input device via Wi-Fi, RFID or other wireless communications protocols.

Locations and people also can have specific identification codes associated with the intermediary. These codes could be alpha-numeric or some form of RFID (or other digital identifier) that signifies the particular location and/or person. Codes will be specific to the intermediary service and prominently displayed on window decals, cash register receipts, customer service rep name tags, etc.

When a repeat customer returns to C&J, the system automatically identifies them based on their caller ID, IP address, cookies, etc. and/or asks them to enter their unique user ID via text input or voice. Note, all previously registered users have any/all related personal information store in their C&J member profile. Also, for those customers who are not registered they may have the option to register now or later. If they choose later, the intermediary sends a reminder to their email and/or communications device with instructions on how to register.

For new customers (not previously registered with C&J), an email address may be all that is required. This allows for anonymity for the customer to provide candid information related to a customer experience. Any additional personal information provided by the customer is optional.

Based on location/store and customer identification all sections which the intermediary has previously stored about the location and customer will auto-populate. Additionally, the customer will have the option to update/modify any information that has been auto-populated.

Registering with Cheers & Jeers

Customers utilizing the intermediary service, may choose to register. Customers who do register could provide information including: name, e-mail, and additional contact information including phone number(s) and preferred method of contact with the intermediary. Prior to submitting any personal information, the customer agrees to the terms and conditions providing customer feedback information, such as the truthfulness of the information being submitted.

Next, customers are asked to list the providers for which they would most likely have a desire to provide customer information related to a customer experience. Customers may be given the option of providing additional information for each organization such as specific locations visited, willingness to be contacted by the participating providers in the future for survey/focus groups, interest in special offers, promotions or events.

Customers may also be presented with the option to sign up for alerts about other items of interest (for example, specific organization's activities, monthly reports published by the intermediary service, etc.). Customer may also create a “buddy list” including friends, family and associates who do, or may, use the intermediary service. Through their buddy lists they would share and/or communicate their experiences and recommendations.

According to other embodiments, under certain conditions (e.g. claims involving financial transactions) there may be a requirement to validate the customer's identity. The intermediary service would do so by asking the customer to submit additional personal data, such as credit card information, driver's license, etc., in order to complete a 3rd party authorization. This and other customer personal information may be stored with a secure user's profile and accessible only by entering the required user ID and password.

Upon registering, customers request a unique Cheers & Jeers user identification (alpha-numeric) and password. If a requested user ID is already in use by another user, the intermediary service instructs the user to suggest a different user ID and/or present options that are similar to the original request. This user ID enables customers to quickly populate feedback incidents and access all historical feedback incidents and related information, if so desired. Additionally, a unique identification and password enables customers to access a secure and personal view of their account, history, and other such personally relevant information. The user's ID can be stored within the user's communication device(s) similar to web sites that allow for the user to select the “remember me” option presented at log-in as an alternative method for logging on to C&J.

The intermediary service may automatically present registered users with the option to access organizations, events, issues, etc. that are geographically and/or demographically relevant to the users profile. For example, the local city government of a particular user is interested in gathering feedback on a recent city ordinance. Based on the user's profile information (in this instance their home address and age), the intermediary service would present them with a customer information template on behalf of the city government.

Providers may choose to reward/reinforce C&J registered customers for taking the time to provide feedback by tracking type and/or number of incidents associated with a particular initiator and automatically award them with a special promotion, offer, discount, entry into a drawing, etc. The intermediary service could track the number of incidents per registered user and automatically send the reward/offer if the providers so desires.

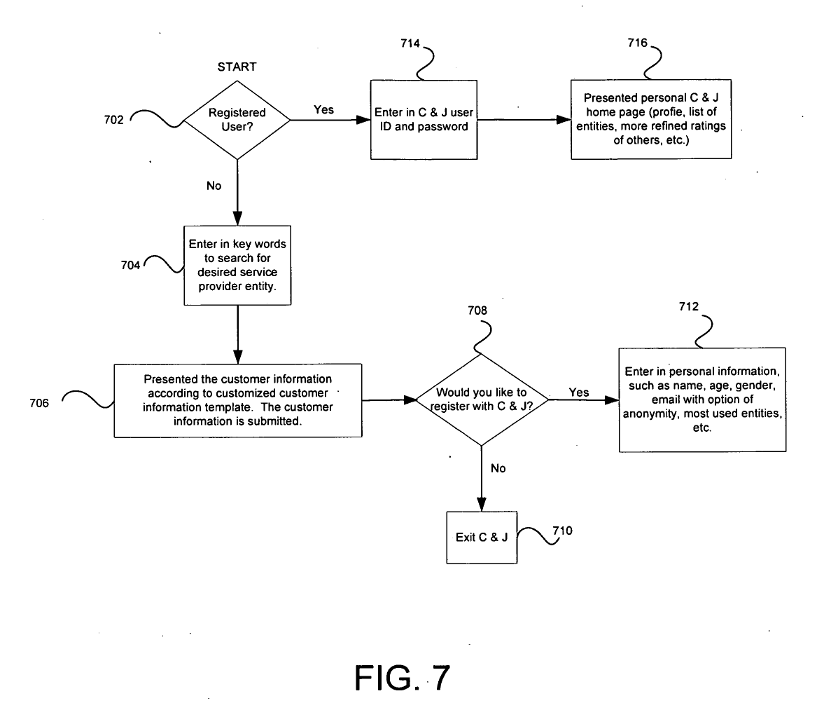

FIG. 7 is an illustrative flowchart showing a customer beginning a session with the intermediary service. The customer accesses the intermediary service through a customer interface, such as a webpage, and will begin by either using a pre-set user ID and password because they have previously registered with the intermediary service 714. Registration allows for quicker access and storage of personal information. Registered users may be offered different incentives and benefits, such as coupons. If the user has chosen not to register before or they are new to the intermediary service, there is an option to go straight to entering your customer information of a customer experience concerning the provider. The customer may begin by searching for the providers that have completed the offers to join the intermediary service 704. Once the provider is found, the customized customer information template for the chosen provider allows the customer to enter the customer information 706. After submission of the customer feedback information, the customer may be asked if they would like to register with the intermediary service. If not, the customer will exit the intermediary system. If so, they need to enter the personal information that will be stored, and is necessary to register.

Advertising by the participating providers and their partners who offer complementary products/services may be presented to the customer based on their user profile, feedback topics, etc. For example, coupons or ads for hardware stores may be presented to customers who expressed interest in home remodeling in their profile.

Initiating a Cheer/Jeer

Using a communications device, customers initiate feedback by, for example, providing inputs to multiple field types including pull-downs, multiple selection, free form text, voice, and file uploads (digital photos, voice, video). Depending on the customer's earlier entries (e.g. a cheer about a staff person vs. a jeer about the organization's environmental practices), different fields will be presented to the customer as they complete their customer experience information. Customer feedback information templates consists of fields including: identification of person(s), place (may be via maps available online, such as Google Maps), time of incident (if applicable), descriptions that make up the customer's experience including product, service, environment, personnel, policies, etc., desired/suggested resolution or action the customer would like the organization to pursue, indication from the customer whether or not they want to submit their customer feedback information without any follow-up and/or tracking of the participating provider's response, and other information the initiator or receiving organization needs to complete a customer feedback information submission.

Some providers may elect to have customers submit customer feedback information via voice and/or graphics (e.g. digital photos or video). This provides the option for receiving a more authentic and complete “voice-of-the-customer” that includes the visuals/emotion as it occurred as close to the incident(s) as possible. These additional forms attaches to all other information related to a specific customer feedback information incident.

Each participating provider organization may have the option to customize the input fields in order to capture the information that is necessary for routing purposes. Additionally, providers have the ability to customize/tailor the “look & feel” (i.e. brand design) of their customer interfaces with the intermediary service.

With each feedback submission, the customer has the option to remain anonymous to the participating organization. In the event the customer prefers to remain anonymous, the C&J system auto-generates a unique alpha-numeric identifier (e.g. “phantom email/phone number/etc.) for the purpose of matching provider responses and further correspondence to the originating customer.

Whether or not a customer remains anonymous, they may elect to be contacted by the provider for resolution and/or follow-up. Additionally, the customer may be given choices concerning who, when and how they are contacted by the provider. These choices could also be stored in the user's profile/preferences and auto-populated for future feedback submissions.

Specific organizations may elect to have staff available for immediate contact, whereby the customer would be presented with a question like “Would you like to connect with the responsible person now? If yes, do you prefer phone, text messaging, chat, etc.?” Upon selection, the customer would be connected to the responsible person via their preferred method.

The intermediary service monitors and enforces all privacy-related concerns as to be defined in the intermediary service's customer privacy policies. These may include anonymity, use of the customer's information, sharing with 3rd parties, etc.

Tracking and Monitoring Feedback

When customer submits a customer information, an auto-generated message will be sent to the customer acknowledging receipt of their feedback. Included will be a tracking number with a hyperlink (used for tracking the progress of initiated feedback or viewing status/history of a previously submitted customer information) and specific expectations regarding who will respond, when they will respond, what will be done with their feedback, etc.

The intermediary system will track & monitor all communication exchanges from beginning-to-end thus ensuring a closed-loop feedback process. From the moment a customer first initiates a session for submission of customer information, the intermediary tracks the content, monitor who is responsible for responding, and when the period ends until the feedback has been handled to the customer's satisfaction.

To the customer's satisfaction means that along with the response(s) from the participating organization, the intermediary service asks the customer (via their preferred method of communication) if their feedback has been “resolved” and if they are satisfied with the response/action taken or not taken. If they are not satisfied, they may be given the option to escalate their feedback to the next level(s) of responsible person(s) within the participating provider organization.

The provider has the ability to control the number of and level(s) of expectations that they would like to set with customers. For example, a confirmation of receipt message may list the name/title of the person who will be contacting them and commit to doing so by 3:30 p.m. EST on Monday, January 16. Additionally, the intermediary service informs them that we are tracking/monitoring the expected response and there is a follow-up and/or escalation on their behalf in the event a response is not received within the expected timeframe. At any point in time the customer also has the ability to check the status of any initiated feedback via the Cheers & Jeers system by entering their unique tracking number, or by viewing their personal history log.

Additionally, providers could establish different expectations based on the organization's classification of a customer. Classification could be by type of customer (e.g. consumer, business, reseller, etc.) and value/importance of customer (e.g. new, gold member, etc.). For instance if a customer initiating feedback is deemed “high value/high importance” to the provider they may choose to have all such customers receive an auto-confirmation of receipt with the name of primary responder, ways to contact them and guaranteed response within 48 hours. Whereas if a customer initiating feedback is deemed “lower value” the auto-response may be anonymous with a promise to respond within 10 business days. Customer value ratings may originate from one or more sources such as an enterprise CRM system, order management system, etc. or may be entered/originated within the intermediary system. The participating provider may provide the intermediary service with their customer classification data which will then be stored in each customer's profile, while maintaining the anonymity preferences of such customers.

Routing Feedback Incidents

Customer inputs are captured into the intermediary system. Structured and unstructured data (e.g. audio file, photograph, etc.) provided by customer is captured and analyzed to determine which organization, department(s) and person(s) are to receive distribution as determined by the roles and responsibilities within the participating organization.

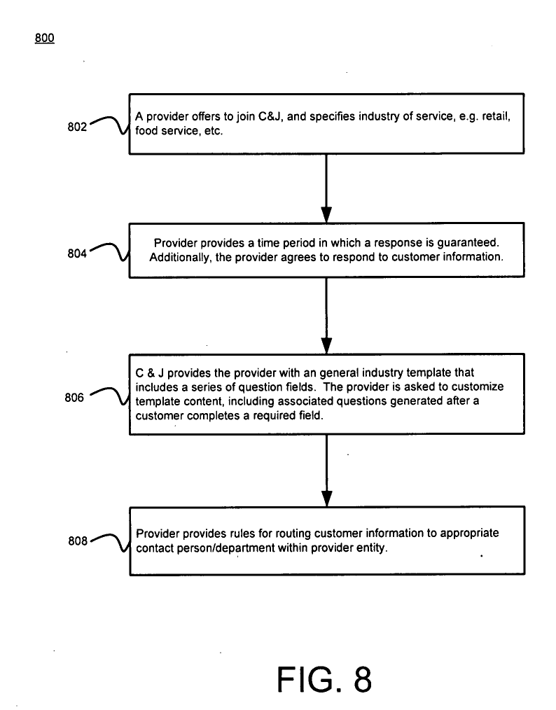

FIG. 8 is an illustrative flowchart showing an embodiment of a provider to offer to use the intermediary service. When the provider first offers to use the intermediary service, the provider will provide information such as the general industry of service they are in 802. The provider may then provide the time period they will commit to respond to submitted customer information 804. The intermediary service may provide a general industry template that include a series of question fields. The provider customizes the template to questions specific to their organization 806. The provider also provides routing rules for allowing the intermediary to determine the appropriate contact entity within the provider.

Based on initiator inputs into fields, the intermediary system routes the incident according to previously defined business rules that contain conditional instructions based on if, and, when, but, then, etc. statements relative to combinations of specific fields. For instance if city (field)=Hometown, and address (field)=210 Main Street, and feedback category (field)=store personnel, when time (field)=3:30 p.m. then route to Sally Jones (store manager) with copy to regional manager, director of customer marketing, etc.

These business rules are configurable by a non-technical user whereby using an interface they create, refine and revise routing rules based on specific combinations of field conditions which will automatically route the incident to the appropriate person(s). This person(s) could be any number of people in different roles within the participating organization.

Each industry type (i.e. airlines, telecommunications, clothing retailers, government, school, etc.) have customer information templates with standard input fields that are specific and necessary for routing customer information within that industry. Over time the intermediary service creates standard feedback taxonomies for each industry. These may be used to quickly set-up organizations within the intermediary service as well as provide customers with a familiar/easy feedback experience that saves time when submitting feedback. The questions/fields may be limited to only those that are required to route and respond to the feedback.

Each input field may have the option of being required or not. Whether a particular field is required or not is decided by the intermediary service and/or the participating provider. Required fields that have not been completed by the initiating customer may prevent the customer feedback information from being accepted by the intermediary. Once the required fields have been completed then the customer feedback information is captured and the routing process begins.

The intermediary service automatically sends all relevant information to the person(s) identified by the participating organization as responsible for responding to the customer as stored in the routing rules. Along with the customer information, the responsible person(s) receive information regarding the expectations for what, when, whom, etc. that have been set with the customer (as determined by the provider's individual rules).

Responsible person(s) also have multiple methods for receiving and responding to feedback including email, Internet, pager, cell phone, etc. as defined by the user within their C&J account. The participating provider and/or individual users may select and use their preferred method for communications through the intermediary service. In the future, as unified messaging and communications solutions become available, these preferences may be set in their organization's authentication/messaging system which pass this along to C&J.

Additionally, as described in section 5-f, specific providers may enable customers to connect with the responsible person immediately upon submitting their feedback. This would require that the responsible person be logged-in to the C&J system indicating that they are available to receive/reply in real-time and able to do so via specific communication methods (e.g. chat, phone, text messaging, etc.).

If, by chance, the responsible person(s) according to the escalation order is incorrect, there may be an opportunity to forward the submission on to the person they believe is responsible. He/she can re-route to the believed correct person by either typing in their last name or any other unique identifier such as title, employee number, etc. (which then searches and lists other users within the participating provider). They can also select them from a pull down list of possible individuals. Additionally, the original recipient may be able to attach a message to the customer information feedback submission indicating why they are not the correct recipient. Alternatively, if the original recipient does not know, or is not sure who the correct person is, they could send the feedback submission back to their internal C&J administrator(s) (with an explanation) for rerouting to the correct person. In either event, the C&J administrator makes the correction and all persons within the organization originally contacted are informed of the change.

Customer feedback information submissions may be sent via the intermediary to the responsible person(s) with possible instant visibility up the management chain. Every customer feedback information submission is sent to the person(s) responsible for responding as well as simultaneously communicated to upper levels of management, for example, including executive staff. The type and frequency of communications to management will vary depending on the organization's desired methods for creating visibility. For example, a Regional Manager would have a secure log-in to C&J where they would access a list of all of their team's feedback submissions (outstanding and closed). These could be sorted by person, type, date, status, etc. If so desired, the Regional Manager could comment/communicate to anyone on his/her team suggesting an action be taken (i.e. send a discount coupon, respond to this customer no later than end of day, etc.). In addition, an executive might see C&Js by type, region, customer, etc. The result is that anyone in the provider can be set-up in the C&J system as a secure user with access to data that is necessary and appropriate to fulfill their role(s) (while abiding by the C&J customer privacy terms and conditions). Based on the data they have visibility to within C&J, customer will be able to view reports and run their own custom ad-hoc reports.

The responsible person responds to feedback through the C&J system using their preferred communication device (phone via VOIP, email via the Internet, etc.). The C&J system will capture and attach all history with the original feedback starting with the initial submission.

In the event the responsible person has not responded within the time period for responding prior to the committed response time, the intermediary service automatically sends a reminder and/or escalation alerting the customer that the response is coming shortly. If the response is not completed within the committed time, the intermediary service may send an auto-generated message to the customer letting them know that their incident has been escalated to the next level of management according to the escalation order set in the rules, for example, and reset their expectations regarding who and when someone will respond to their original feedback. The escalation order could indicate the same person within the provider will receive the customer information again and will need to provide the customer with another response.

Each user has a unique log-in to the C&J system where they manage individual system preferences and, access other administrative and reporting features. In the case of auto-reminders, these may be a user-controlled preference within C&J whereby users can elect whether or not to have reminders sent along with the amount of time prior to when the response is due that they would like to receive the reminder, and elect how they want to receive their reminders (e.g. cellular, email, etc.) without any limit to the number of preferred communication devices.

The intermediary presents customer information feedback submissions to responders in a prioritized list showing response due date/time, customer type, customer information feedback submission type, importance, etc. The list can be re-sorted by the user at any time by clicking on the header of a specific category.

Upon receipt of communication, the primary responder can respond to the customer via the intermediary service. Depending on an organization's policies some responses (as determined by the participating organization) may require review and/or approval by other departments/persons prior to the intermediary service releasing it to the customer. In such cases the intermediary service automatically routes the response to the appropriate dept/person according to an escalation order set in the rules. The reviewer/approver can approve the response which then enables the intermediary service to release it to the customer. If it is not approved, the reviewer is prompted to reply to the responder and include a message as to why it has not been approved.

If so desired, participating providers will also have the ability to maintain the anonymity of the responder entity. Some providers may not want customers to have ready access to the full name, email, phone number, etc. of the employee.

Provider organization, departments or individuals may elect to create and/or capture standard responses that are related to specific type(s) of customer information feedback submissions. The standard responses are made available to the responder at the time a response is being developed. The provider may have standard responses that are locked (cannot be modified by the responder) partially locked (specific words/sections can be modified by the responder entities) or unlocked (any words/sections can be modified by responder). Note that standard responses apply to customer correspondence as well as internal organization correspondence.

Closing Out a Cheer/Jeer

A customer information submission may require multiple exchanges of information between the customer and responder entities within the provider via the intermediary service.

A customer information submission is monitored and tracked until the customer decides to take no further direct action with the organization. At this point the feedback submission is considered closed and labeled as such.

The intermediary service asks the initiating customer if they are ready to “close out” their submission with the organization. If they select no, then the customer will be presented with another opportunity to respond to the provider's response. Some providers may decide to have the intermediary system automatically escalate a customer information feedback incident after a certain number of exchanges between the customer and the primary responder entity. Also, at any point in time if the primary responder entity may decide that the incident should be escalated and they may do so according to the escalation order, as predetermined by the provider's rules.

When the customer decides to “close out” a customer information submission (positive, negative or neutral) the intermediary service may survey the customer asking them to rate their before and after thoughts about actions they may take including, but not limited to:
Are you satisfied with the outcome of your incident? If yes, are you willing to participate in a follow-up survey with the participating provider? If not, they may be presented with additional actions they can take (i.e. contact 3rd party watch dog, redirect to a community blog to share their experience, etc.)
Do you intend to continue supporting/doing business with this provider?
Would you recommend this provider to others?
Feelings about how they would rank this org vs. others (e.g. competitors)

The customer may chose not to answer the survey questions.

At any point throughout an exchange the customer may be presented with the option to share the contents of the customer information feedback by forwarding it to another third party. They will have the opportunity to attach additional content (text, pictures, voice, etc.) prior to forwarding their feedback.

Each feedback submission will have a unique tracking identifier (alpha numeric) attached at the beginning and retained through “close out” for the purpose of common identification by the customer and participating provider.

Once the customer has chosen to “close out” a customer information submission this incident is saved and displayed in the customer's list of “Closed Out” items along with any “Open/Pending” items. This requires that the customer initiator be a registered user. The status of customer information submissions are displayed in the participating provider's views.

As a primary responder entity within the provider evaluates/investigates/responds/resolves the feedback, he can then rate the accuracy and reliability of the original customer's feedback. This can be done with each individual customer information incident. Each user will have a cumulative accuracy/reliability rating viewable by individuals within the participating provider and the intermediary service.

Upon completing the investigation of a specific feedback submission, the responder indicates which aspect(s) of the customer's expectations were not met, or exceeded. These expectations could be what many organizations refer to as their “brand promise.” For example, “When you (the customer) conduct business with us, this is what you can expect in terms of our product/service and the way you will be treated!” Depending on the causes selected whether it be positive or negative (e.g. long wait times, exceeding customer expectations, etc.), the intermediary service may offer suggestions on what actions could be taken by the frontline employee's manager to address a problem or encourage desirable outcomes. This could be a tool, training, reward, etc.

Analyzing and Reporting Feedback Data

Content generated throughout feedback submissions may be captured and indexed in the C&J data warehouse. Data in this warehouse will be utilized to generate reports for several constituents including provider's management, customers, investors and the general public.

Based on previously determined organizational goals related to handling customer feedback (e.g. type, response time, customer satisfaction, etc.,) management may receive regular activity reports. As actions/responses are taken by all parties, the intermediary service tracks all activities and create an audit trail for purposes of measuring and reporting performance. The intermediary service provides management with a performance dashboard where they can view the past and current performance relative to the customer information feedback received and handling of the feedback.

Additionally, auto-alerts can be created by individuals whereby they set a pre-defined threshold of feedback criteria (total number, submission within y time, type of submissions, etc.). When the threshold criteria are met, he/she receives an auto-generated message informing them of the situation along with access to the data and/or reports supporting the alert.

Additionally, management can run/access up-to-date reports in the intermediary service. Tracking numbers are assigned to each incident which provides users with one click access to the history of a particular customer information submission for audit and troubleshooting purposes. Integrated business intelligence tools enables management to create personalized feedback “dashboards” for showing things like historical and current performance in feedback areas. These reports demonstrate trends providing insights into failures/opportunities for improvement and differentiation.

Customer information feedback data is aggregated by industries, geographies and providers. From this, the intermediary service produces competitive benchmarking reports, ratings and indices. Management of a provider may be able to see how they rank/compare against others in general and in specific feedback categories. Comparisons could be made by location, industry, “best-in-class”, “worst-in-class” and perhaps even specific organizations (depending on the participating organization's intermediary use policy).

Providers may be able to provide an organizational response to recurring feedback categories that can be sent to all customers who contributed to the specific feedback. The participating provider's response may inform those customers (those who contributed to the feedback category) know what the organization has done or plans to do with the said feedback. The reports and responses may be made available to the general public as well if desired by the participating organization.

Customers can utilize the intermediary service to compare multiple providers' performance overall and in particular areas. Customers may access aggregate ratings to see how their experience(s) compares to others from the general user base as well as customers with like profile attributes and their “my buddies” list. They may also be able to access comparison data that shows differences by industry, region, feedback type and, possibly specific organizations. Customers may also be given the opportunity to subscribe to reports from the intermediary service.

Through ratings, benchmarking and indices investors can gain insights into leading indicators of an organization's future performance. The intermediary service generates customer-related indices by industry, organization, topic, etc. These indices may provide the market with an aggregate pulse of what customers are thinking/feeling relative to a host of items including customer loyalty, likelihood to recommend, customer satisfaction, intent to repurchase, etc. As the indices are tracked and correlated to actual organizational performance (i.e. revenues, market share, retention, profits, etc.) the indices may become a gauge of leading indicators of future organization performance.

Additional Applications

Registered users may have the opportunity to access ratings of participating providers that were completed by other registered users who share all, or aspects of, their user profile. For instance, a male, age 37, Asian, interested in Indian food could find rankings of Indian restaurants in a particular area that were completed by other C&J users matching his profile criteria above.

Registered users can also search for other registered users who share profile and/or similar ratings of institutions. As users identify these “like-minded” individuals they can save them to a “my buddies” category. The my buddies category can be saved and will automatically receive updates as buddies submit additional ratings. Anonymity of “my buddies” are maintained unless the individuals both agree to share their identities.

Registered users may have the option to create and join blogs (threaded discussions) related to a specific feedback topic and report(s). The participating providers can monitor and respond to these communities and their concerns. This provides the opportunity for community activities related to specific topics to take place (threaded discussions, conference call/presentation by organization with a response, additional customers “voting” their stance/experience on a particular topic, etc.). It enables marketers to gain real-time customer insights by: Running reports to gather data as customers are submitting their feedback about the participating provider's performance, Identifying an issue or potential issue early, Contacting customers who previously submitted customer information feedback on a specific topic (and agreed to the possibility of being contacted by the participating provider), and asking additional questions/opinions to more fully understand the customer's experience, needs, suggestions, etc.

Based on recurring feedback topics, participating providers can respond to all people who submitted feedback via the intermediary service on a specific topic to let them know what they have done or are doing to address their feedback. This lets their customers know that they are listening to their feedback and, most importantly, doing something with it to improve their delivery of products and services. This sort of continuing dialog between providers and their customers reinforces to customers that their feedback results in changes to the way organizations operate.

Participating providers could-be placed into different C&J categories according to their participation in C&J. Participation could be measured by several factors including: Guaranteed response time, Level of executive staff commitment and participation, percentage of feedback submissions closed out and/or escalated to another 3rd party. Categories could include “C&J Platinum, Gold, Lead.”

1. A method for operating an intermediary over a network for mediating communication between a customer and a provider, the method comprising:
storing a set of rules for managing customer feedback information for the provider, wherein the rules include rules for routing the customer feedback information to appropriate entities within the provider according to an escalation order, and rules for responding to the customer feedback information within a time period;
providing a customer satisfaction submission protocol for customization by each provider of a plurality of providers;
receiving the customer feedback information over the network from the customer indicating a customer experience concerning the provider via the customer satisfaction submission protocol;
(A) providing over the network the customer feedback information to an appropriate entity within the provider according to the escalation order in the rules;
(B) providing over the network to the customer an indication of at least one action to be taken by the provider in response to the customer feedback information;
(C) providing over the network to the customer a time period for responding to the customer feedback information by the provider;
(D) receiving over the network from the provider a response indicating a performance of at least one action in response to the customer feedback information;
(E) receiving from the customer an indication of a level of customer satisfaction with the received response from the provider; and
if the received indication of the level of customer satisfaction indicates the customer is not satisfied, then escalating the customer information to a next entity in the escalation order and repeating (A)-(E).

2. The method of claim 1, wherein the rules include an agreement for the provider to provide at least one response in response to receipt of customer feedback information after opening a session concerning customer experience from the intermediary.

3. The method of claim 1, further comprising providing reminders to the provider when the provider has not responded in the time period set in the rules for responding.

4. The method of claim 1, further comprising providing incentive information to the customer based on customer interests.

5. The method of claim 1, wherein the customer feedback information concerning customer experience is a member of the group consisting of a negative statement, a positive statement, and a neutral statement.

6. The method of claim 1, further comprising:
if the received indication of the level of customer satisfaction indicates the customer wishes to end communication concerning the customer feedback information,
receiving from the customer indications of future intentions associated with the provider; and
providing received indications of future intentions to the provider.

7. The method of claim 1, further comprising receiving from the provider a rating of the customer.

8. The method of claim 1, further comprising receiving from the customer a rating of the provider.

9. The method of claim 1, further comprising:
receiving from the provider a rating of the customer; and
receiving from the customer a rating of the provider.

10. The method of claim 1, further comprising providing the customer an expectation of the provider, wherein the expectation includes the entity in the escalation order responsible for responding to the customer feedback information and the time period for responding.

11. The method of claim 1, wherein the customer satisfaction submission protocol includes a template.

12. The method of claim 11, wherein the template comprises a series of fields, wherein the fields include fields containing customer choices and fields for customer-entered information.

13. The method of claim 12, wherein the fields including customer choices dynamically generate the next field in the series of fields, depending on previous input by the customer.

14. The method of claim 12, wherein at least one field is associated with the routing rules.

15. The method of claim 1, wherein the customer satisfaction submission protocol is an interactive voice response (IVR) protocol.

16. The method of claim 1, wherein the rules include rules of responses that are acceptable to the provider.

17. An article of manufacture including computer readable medium encoded with program code causing a computing device to perform a process comprising:
storing a set of rules for managing customer feedback information for the provider, wherein the rules include rules for routing the customer feedback information to appropriate entities within the provider according to an escalation order, and rules for responding to the customer feedback information within a time period;
providing a customer satisfaction submission protocol for customization by each provider of a plurality of providers,
receiving the customer feedback information over the network from the customer indicating a customer experience concerning the provider via the customer satisfaction submission protocol,
(A) providing over the network the customer feedback information to an appropriate entity within the provider according to the escalation order in the rules;
(B) providing over the network to the customer an indication of at least one action to be taken by the provider in response to the customer feedback information;
(C) providing over the network to the customer a time period for responding to the customer feedback information by the provider;
(D) receiving over the network from the provider a response indicating a performance of at least one action in response to the customer feedback information;
(E) receiving from the customer an indication of a level of customer satisfaction with the received response from the provider; and
if the received indication of the level of customer satisfaction indicates the customer is not satisfied, then escalating the customer information to a next entity in the escalation order and repeating (A)-(E).

18. The article of claim 17, wherein the rules include an agreement for the provider to provide at least one response in response to receipt of customer feedback information after opening a session concerning customer experience from the intermediary.

19. The article of claim 17, wherein the process further includes providing reminders to the provider when the provider has not responded in the time period set in the rules for responding.

20. The article of claim 17, wherein the process further includes providing incentive information to the customer based on customer interests.

21. The article of claim 17, wherein the customer feedback information concerning customer experience is a member of the group consisting of a negative statement, a positive statement, and a neutral statement.

22. The article of claim 17, wherein the process further includes, if the received indication of the level of customer satisfaction indicates the customer wishes to end communication concerning the customer feedback information:
receiving from the customer indications of future intentions associated with the provider; and
providing received indications of future intentions to the provider.

23. The article of claim 17, wherein the process further includes receiving from the provider a rating of the customer.

24. The article of claim 17, wherein the process further includes receiving from the customer a rating of the provider.

25. The article of claim 17, wherein the process further includes:
receiving from the provider a rating of the customer; and
receiving from the customer a rating of the provider.

26. The article of claim 17, wherein the process further includes providing the customer a new expectation of the provider, wherein the new expectation includes the entity in the escalation order responsible for responding to the customer feedback information and the time period for responding.

27. The article of claim 17, wherein the customer satisfaction submission protocol includes a template.

28. The article of claim 27, wherein the template comprises a series of fields, wherein the fields include fields containing customer choices and fields for customer-entered information.

29. The article of claim 28, wherein the fields including customer choices dynamically generate the next field in the series of fields, depending on previous input by the customer.

30. The article of claim 28, wherein at least one field is associated with the routing rules.

31. The article of claim 17, wherein the customer satisfaction submission protocol is an interactive voice response (IVR) protocol.

32. The article of claim 17, wherein the rules include rules of responses that are acceptable to the provider.

33. A system for an intermediary for mediating communications between a customer of a plurality of customers and a provider from a plurality of providers over a network, the system comprising:
a processor;
a memory;
a bus coupling the memory to the processor;
wherein the memory stores code causing the processor to perform a process comprising:
storing a set of rules for managing customer feedback information for the provider, wherein the rules include rules for routing the customer feedback information to appropriate entities within the provider according to an escalation order, and rules for responding to the customer feedback information within a time period;
providing a customer satisfaction submission protocol for customization by each provider of a plurality of providers;
receiving the customer feedback information over the network from the customer indicating a customer experience concerning the provider via the customer satisfaction submission protocol;
(A) providing over the network the customer feedback information to an appropriate entity within the provider according to the escalation order in the rules;
(B) providing over the network to the customer an indication of at least one action to be taken by the provider in response to- the customer feedback information;
(C) providing over the network to the customer a time period for responding to the customer feedback information by the provider;
(D) receiving over the network from the provider a response indicating a performance of at least one action in response to the customer feedback information;
(E) receiving from the customer an indication of a level of customer satisfaction with the received response from the provider; and
if the received indication of the level of customer satisfaction indicates the customer is not satisfied, then escalating the customer information to a next entity in the escalation order and repeating (A)-(E).

34. The system of claim 33, wherein the rules include an agreement for the provider to provide at least one response in response to receipt of customer feedback information after opening a session concerning customer experience from the intermediary.

35. The system of claim 33, wherein the process further includes providing reminders to the provider when the provider has not responded in the time period set in the rules for responding.

36. The system of claim 33, wherein the process further includes providing incentive information to the customer based on customer interests.

37. The system of claim 33, wherein the customer feedback information concerning customer experience is a member of the group consisting of a negative statement, a positive statement, and a neutral statement.

38. The system of claim 33, wherein the process further includes:
if the received indication of the level of customer satisfaction indicates the customer wishes to end communication concerning the customer feedback information,
receiving from the customer indications of future intentions associated with the provider; and
providing received indications of future intentions to the provider.

39. The system of claim 33, wherein the process further includes receiving from the provider a rating of the customer.

40. The system of claim 33, wherein the processor further causes the step of receiving from the customer a rating of the provider.

41. The system of claim 33, wherein the process further includes:
receiving from the provider a rating of the customer; and
receiving from the customer a rating of the provider.

42. The system of claim 33, wherein the process further includes providing the customer an expectation of the provider, wherein the expectation includes the entity in the escalation order responsible for responding to the customer feedback information and the time period for responding.

43. The system claim 33, wherein the customer satisfaction'submission protocol includes a template.

44. The system of claim 43, wherein the template comprises a series of fields, wherein the fields include fields containing customer choices and fields for customer-entered information.

45. The system of claim 44, wherein the fields including customer choices dynamically generate the next field in the series of fields, depending on previous input by the customer.

46. The system of claim 44, wherein at least one field is associated with the routing rules.

47. The system of claim 33, wherein the customer satisfaction submission protocol is an interactive voice response (IVR) protocol.

48. The system of claim 33, wherein the rules include rules of responses that are acceptable to the provider.
